(19) United States
(12) Patent Application Publication
(10) Pub. No.: US 2023/0420713 A1
(43) Pub. Date: Dec. 28, 2023

(54) FUEL CELL SYSTEM CONTROL APPARATUS, SYSTEM INCLUDING THE SAME, AND METHOD THEREOF

(71) Applicants: Hyundai Motor Company, Seoul (KR); Kia Corporation, Seoul (KR)

(72) Inventor: Jae Gwang LEE, Seoul (KR)

(73) Assignees: Hyundai Motor Company, Seoul (KR); Kia Corporation, Seoul (KR)

(21) Appl. No.: 18/132,139

(22) Filed: Apr. 7, 2023

(30) Foreign Application Priority Data
Aug. 26, 2022 (KR) 10-2022-0107753

(51) Int. Cl. H01M 8/04858; H01M 8/04537; H01M 8/04228; H01M 8/04992; H01M 8/04303; B60L 3/00; B60L 3/04

(52) U.S. Cl. CPC H01M 8/0494; H01M 8/04619; H01M 8/04228; H01M 8/04992; H01M 8/04303; B60L 3/0053; B60L 3/04

(57) ABSTRACT

An apparatus of controlling a multi-module fuel cell system, a system including the same, and a method thereof are provided. A first controller individually monitors at least one of an amount of accumulated power or an accumulated driving time of one or more fuel cell stacks and a second controller is configured to control power of each of the one or more, based on the amount of monitored individual accumulated power or the monitored individual accumulated driving time of the one or more fuel cell stacks depending on required power. Stack durability is ensured by controlling distribution of the fuel cell stacks.

### CROSS-REFERENCE TO RELATED APPLICATION

The present application claims priority to Korean Patent Application No. 10-2022-0107753, filed on Aug. 26, 2022, the entire contents of which is incorporated herein for all purposes by this reference.

### BACKGROUND OF THE PRESENT DISCLOSURE

### Field of the Present Disclosure

The present disclosure relates to a fuel cell system control apparatus, a system including the same, and a method thereof, and more particularly, relates to an apparatus of controlling a multi-module fuel cell system, a system including the same, and a method thereof.

### Description of Related Art

In general, a fuel cell vehicle includes a fuel cell stack in which a plurality of fuel cells used as a power source are laminated, a fuel supply system for supplying hydrogen or the like which is a fuel to the fuel cell stack, an air supply system for supplying oxygen which is an oxidizing agent necessary for electrochemical reaction, a water and heat management system for controlling a temperature of the fuel cell stack, and the like.

Power required for each fuel cell stack of an existing fuel cell system is uniformly determined as a value obtained by dividing total required power by the number of stacks. Furthermore, all fuel cell stacks generate power depending on required power. Thus, when irreversible deterioration or failure occurs in some fuel cell stacks, the power of the fuel cell system is degraded. Thus, there is a need to develop a technology for addressing such problems.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus of controlling a multi-module fuel cell system, a system including the same, and a method thereof.

Another aspect of the present disclosure provides a fuel cell system control apparatus of ensuring stack durability by controlling distribution of fuel cell stacks, a system including the same, and a method thereof.

Another aspect of the present disclosure provides a fuel cell system control apparatus of preventing stack power from being degraded by diagnosing and monitoring stacks and scheduling power of the stacks, a system including the same, and a method thereof.

Another aspect of the present disclosure provides a fuel cell system control apparatus of addressing a problem in which power of a fuel cell system is degraded when irreversible deterioration or failure occurs in some fuel cell stacks, a system including the same, and a method thereof.

Another aspect of the present disclosure provides a fuel cell system control apparatus of addressing a problem in which the sum of power of individual stacks upon minimum power control due to characteristics of a multi-module fuel cell system, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell system control apparatus may include a first controller that is configured to monitor at least one of an amount of accumulated power or an accumulated driving time of a plurality of fuel cell stacks and a second controller that is configured to control power of each of the fuel cell stacks, based on the amount of monitored accumulated power or the monitored accumulated driving time of the plurality of fuel cell stacks depending on required power.

In an exemplary embodiment of the present disclosure, the second controller may be configured to determine a power level of each of the fuel cell stacks, based on the required power and a number of drivable fuel cell stacks.

In an exemplary embodiment of the present disclosure, the second controller may be configured to determine a power level of each of the fuel cell stacks, based on whether a value obtained by dividing the required power by power corresponding to each power level is greater than the number of drivable fuel cell stacks.

In an exemplary embodiment of the present disclosure, the second controller may apply hysteresis to the required power or a number of drivable fuel cell stacks to determine a power level of each of the fuel cell stacks.

In an exemplary embodiment of the present disclosure, the second controller may be configured to determine the number of driving fuel cell stacks, based on a value obtained by dividing the required power by power corresponding to the determined power level.

In an exemplary embodiment of the present disclosure, the second controller may stop driving a fuel cell stack, a continuously driven time or an amount of continuously output power of which is greater than a threshold time or a threshold amount of power corresponding to the power of each of the fuel cell stack, or may decrease power of the fuel cell stack.

In an exemplary embodiment of the present disclosure, the second controller may drive another fuel cell stack to replace a fuel cell stack, a continuously driven time or an amount of continuously output power of which is greater than a threshold time or a threshold amount of power corresponding to the power of each of the fuel cell stack, or may increase power of the other fuel cell stack.

In an exemplary embodiment of the present disclosure, the second controller may replace a fuel cell stack, a continuously driven time or an amount of continuously output power of which is greater than a threshold time or a threshold amount of power corresponding to the power of each of the fuel cell stack, with a fuel cell stack with a shortest accumulated driving time or a smallest amount of accumulated power among the plurality of fuel cell stacks.

In an exemplary embodiment of the present disclosure, the second controller may be configured to determine the number of representative fuel cell stacks with a smallest amount of accumulated power or a shortest accumulated driving time among the plurality of fuel cell stacks, based on the required power, the number of the driving fuel cell stacks, the power corresponding to the determined power level, and power corresponding to a power level which is one step higher than the determined power level.

In an exemplary embodiment of the present disclosure, the second controller may be configured to determine fuel cell stacks with a smallest amount of accumulated power or a shortest accumulated driving time among the plurality of fuel cell stacks as representative fuel cell stacks and may determine power of each of the remaining driven fuel cell stacks except for the representative fuel cell stacks, based on power corresponding to the determined power level.

In an exemplary embodiment of the present disclosure, the second controller may be configured to determine power of the representative fuel cell stacks, based on a value obtained by dividing a value obtained by subtracting a sum of the power of the remaining driven fuel cell stacks except for the representative fuel cell stacks from the required power by the number of the representative fuel cell stacks.

In an exemplary embodiment of the present disclosure, the second controller may be configured to generate remaining power by a separate high voltage battery, when the required power is greater than a value obtained by multiplying a total number of drivable fuel cell stacks among the plurality of fuel cell stacks by power corresponding to a highest power level.

In an exemplary embodiment of the present disclosure, the fuel cell system control apparatus may further include an output device that outputs a warning about power insufficiency of a fuel cell system, when the required power is greater than a value obtained by multiplying a total number of drivable fuel cell stacks among the plurality of fuel cell stacks by power corresponding to a highest power level.

In an exemplary embodiment of the present disclosure, the second controller may be configured to determine whether the required power is greater than or equal to predetermined reference power and may generate the required power by a fuel cell stack with a largest amount of accumulated power or a longest accumulated driving time among the plurality of fuel cell stack, when the required power is not greater than or equal to the predetermined reference power.

In an exemplary embodiment of the present disclosure, the second controller may be configured to determine whether the required power is greater than or equal to predetermined reference power and may determine a fuel cell stack to be replaced, based on whether there is a fuel cell stack which outputs power corresponding to a highest power level continuously above a predetermined first reference time or whether there is a fuel cell stack which outputs power corresponding to a power level which is one step lower than the highest power level continuously above a predetermined second reference time, when the required power is greater than or equal to the predetermined reference power.

In an exemplary embodiment of the present disclosure, the second controller may replace the fuel cell stack to be replaced with a fuel cell stack with a smallest amount of accumulated power or a shortest accumulated driving time among the plurality of fuel cell stacks.

In an exemplary embodiment of the present disclosure, the second controller may be configured to control a positive slew rate, which is power of the fuel cell stack to be replaced, the power decreasing per hour, and a positive slew rate, which is power of a fuel cell stack to replace the fuel cell stack to be replaced, the power increasing per hour, to be the same as each other.

In an exemplary embodiment of the present disclosure, the second controller may be configured to determine a value dividing a difference between the required power and power of a fuel cell stack to replace the fuel cell stack to be replaced by a magnitude of power increasing per hour.

In an exemplary embodiment of the present disclosure, the second controller may initiate to increase power of the fuel cell stack to be replaced before a time corresponding to the value obtained by dividing the difference between the required power and the power of the fuel cell stack to replace the fuel cell stack to be replaced by the magnitude of the power increasing per hour, when starting of the fuel cell stack to replace the fuel cell stack is already completed.

In an exemplary embodiment of the present disclosure, the second controller may initiate to start the fuel cell stack to be replaced before a time obtained by adding a time necessary to start the fuel cell stack to be replaced to a time corresponding to the value obtained by dividing the difference between the required power and the power of the fuel cell stack to replace the fuel cell stack to be replaced by the magnitude of the power increasing per hour, when starting of the fuel cell stack to replace the fuel cell stack is not already completed.

According to another aspect of the present disclosure, a fuel cell system may include a plurality of fuel cell stacks and a fuel cell system control apparatus that monitors at least one of an amount of accumulated power or an accumulated driving time of a plurality of fuel cell stacks and controls power of each of the fuel cell stacks, based on the amount of monitored accumulated power or the monitored accumulated driving time of the plurality of fuel cell stacks depending on required power.

In an exemplary embodiment of the present disclosure, the fuel cell system control apparatus may determine a power level of each of the fuel cell stacks, based on the required power and a number of drivable fuel cell stacks.

In an exemplary embodiment of the present disclosure, the fuel cell system control apparatus may determine a power level of each of the fuel cell stacks, based on whether a value obtained by dividing the required power by power corresponding to each power level is greater than the number of drivable fuel cell stacks.

In an exemplary embodiment of the present disclosure, the fuel cell system control apparatus may determine the number of driving fuel cell stacks, based on a value obtained by dividing the required power by power corresponding to the determined power level.

In an exemplary embodiment of the present disclosure, the fuel cell system control apparatus may stop driving a fuel cell stack, a continuously driven time or an amount of continuously output power of which is greater than a threshold time or a threshold amount of power corresponding to the power of each of the fuel cell stack, or may decrease power of the fuel cell stack.

In an exemplary embodiment of the present disclosure, the fuel cell system control apparatus may drive another fuel cell stack to replace a fuel cell stack, a continuously driven time or an amount of continuously output power of which is greater than a threshold time or a threshold amount of power corresponding to the power of each of the fuel cell stack, or may increase power of the other fuel cell stack.

In an exemplary embodiment of the present disclosure, the fuel cell system control apparatus may replace a fuel cell stack, a continuously driven time or an amount of continuously output power of which is greater than a threshold time or a threshold amount of power corresponding to the power of each of the fuel cell stack, with a fuel cell stack with a shortest accumulated driving time or a smallest amount of accumulated power among the plurality of fuel cell stacks.

In an exemplary embodiment of the present disclosure, the fuel cell system control apparatus may determine the number of representative fuel cell stacks with a smallest amount of accumulated power or a shortest accumulated driving time among the plurality of fuel cell stacks, based on the required power, the number of the driving fuel cell stacks, the power corresponding to the determined power level, and power corresponding to a power level which is one step higher than the determined power level.

In an exemplary embodiment of the present disclosure, the fuel cell system control apparatus may determine fuel cell stacks with a smallest amount of accumulated power or a shortest accumulated driving time among the plurality of fuel cell stacks as representative fuel cell stacks, may determine power of each of the remaining driven fuel cell stacks except for the representative fuel cell stacks, based on power corresponding to the determined power level, and may determine power of the representative fuel cell stacks, based on a value obtained by dividing a value obtained by subtracting a sum of the power of the remaining driven fuel cell stacks except for the representative fuel cell stacks from the required power by the number of the representative fuel cell stacks.

In an exemplary embodiment of the present disclosure, the fuel cell system may further include a high voltage battery that generates remaining power, when the required power is greater than a value obtained by multiplying a total number of drivable fuel cell stacks among the plurality of fuel cell stacks by power corresponding to a highest power level.

According to another aspect of the present disclosure, a fuel cell system control method may include monitoring, by a first controller, at least one of an amount of accumulated power or an accumulated driving time of a plurality of fuel cell stacks and controlling, by a second controller, power of each of the fuel cell stacks, based on the amount of monitored accumulated power or the monitored accumulated driving time of the plurality of fuel cell stacks depending on required power.

In an exemplary embodiment of the present disclosure, the fuel cell system control method may further include determining, by the second controller, a power level of each of the fuel cell stacks, based on the required power and a number of drivable fuel cell stacks.

In an exemplary embodiment of the present disclosure, the fuel cell system control method may further include determining, by the second controller, the number of driving fuel cell stacks, based on a value obtained by dividing the required power by power corresponding to the determined power level.

In an exemplary embodiment of the present disclosure, the controlling of the power of each of the fuel cell stacks by the second controller may include stopping, by the second controller, driving a fuel cell stack, a continuously driven time or an amount of continuously output power of which is greater than a threshold time or a threshold amount of power corresponding to the power of each of the fuel cell stack, or decreasing, by the second controller, power of the fuel cell stack.

In an exemplary embodiment of the present disclosure, the fuel cell system control method may further include replacing, by the second controller, a fuel cell stack, a continuously driven time or an amount of continuously output power of which is greater than a threshold time or a threshold amount of power corresponding to the power of each of the fuel cell stack, with a fuel cell stack with a shortest accumulated driving time or a smallest amount of accumulated power among the plurality of fuel cell stacks.

In an exemplary embodiment of the present disclosure, the controlling of the power of each of the fuel cell stacks by the second controller may include determining, by the second controller, the number of representative fuel cell stacks with a smallest amount of accumulated power or a shortest accumulated driving time among the plurality of fuel cell stacks, based on the required power, the number of the driving fuel cell stacks, the power corresponding to the determined power level, and power corresponding to a power level which is one step higher than the determined power level.

In an exemplary embodiment of the present disclosure, the controlling of the power of each of the fuel cell stacks by the second controller may include determining, by the second controller, fuel cell stacks with a smallest amount of accumulated power or a shortest accumulated driving time among the plurality of fuel cell stacks as representative fuel cells and determining, by the second controller, power of each of the remaining driven fuel cell stacks except for the representative fuel cell stacks, based on power corresponding to the determined power level.

In an exemplary embodiment of the present disclosure, the controlling of the power of each of the fuel cell stacks by the second controller may include determining, by the second controller, power of the representative fuel cell stacks, based on a value obtained by dividing a value obtained by subtracting a sum of the power of the remaining driven fuel cell stacks except for the representative fuel cell stacks from the required power by the number of the representative fuel cell stacks.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a fuel cell system control apparatus according to an exemplary embodiment of the present disclosure;

FIG. 2 is a drawing illustrating a detailed configuration of a fuel cell system according to an exemplary embodiment of the present disclosure;

FIG. 3 is a drawing illustrating that a fuel cell system control apparatus replaces a fuel cell stack over a time when the fuel cell stack is continuously driven according to an exemplary embodiment of the present disclosure;

FIG. 4 and FIG. 5 are drawings illustrating an accumulated time product factor according to power of a fuel cell stack according to an exemplary embodiment of the present disclosure;

FIG. 6 is a flowchart illustrating that a fuel cell system control apparatus is configured to determine the number of starts of a fuel cell stack and power of the fuel cell stack according to an exemplary embodiment of the present disclosure;

FIG. 7 is a flowchart illustrating that a fuel cell system control apparatus replaces a fuel cell stack according to an exemplary embodiment of the present disclosure;

FIG. 8 is a block diagram illustrating a fuel cell system according to an exemplary embodiment of the present disclosure;

FIG. 9 is a flowchart illustrating a fuel cell system control method according to an exemplary embodiment of the present disclosure; and

FIG. 10 illustrates a computing system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In the drawings, the same reference numerals will be used throughout to designate the same or equivalent elements. Furthermore, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

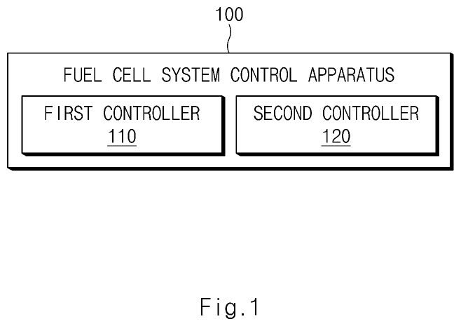

Hereinafter, various embodiments of the present disclosure will be described in detail with reference to FIGS. 1 to 10.

FIG. 1 is a block diagram illustrating a fuel cell system control apparatus according to an exemplary embodiment of the present disclosure;

The fuel cell system control apparatus 100 according to an exemplary embodiment of the present disclosure may be implemented inside or outside a fuel cell system. In the instant case, the fuel cell system control apparatus 100 may be integrally configured with control units in the fuel cell system or may be implemented as a separate hardware device to be connected to the control units of the fuel cell system by a connection means.

As an exemplary embodiment of the present disclosure, the fuel cell system control apparatus 100 may be integrally configured with the fuel cell system or may be implemented as a configuration independent of the fuel cell system in a form of being installed/attached to the fuel cell system. Alternatively, a part of the fuel cell system control apparatus 100 may be integrally configured with the fuel cell system or the other may be implemented as a configuration independent of the fuel cell system in a form of being installed/attached to the fuel cell system.

As an exemplary embodiment of the present disclosure, the fuel cell system may be provided in the vehicle to supply power to a motor and other auxiliary machinery of the vehicle.

Referring to FIG. 1, the fuel cell system control apparatus 100 may include a first controller 110 and a second controller 120.

Each of the first controller 110 and the second controller 120 may include a processor which performs data processing and/or calculation described below. Furthermore, each of the first controller 110 and the second controller 120 may include a memory which stores data or an algorithm required in a process of performing data processing and/or calculation.

The processor which may be included in each of the first controller 110 and the second controller 120 may be an electrical circuit which executes a command of software. For example, the processor included in each of the first controller 110 and the second controller 120 may be a fuel-cell control unit (FCU), an electronic control unit (ECU), a micro controller unit (MCU), or another sub-controller.

The memory which may be included in each of the first controller 110 and the second controller 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, or an optical disk.

The first controller 110 may monitor at least one of an amount of accumulated power or an accumulated driving time of a plurality of fuel cell stacks.

As an exemplary embodiment of the present disclosure, the first controller 110 may include a non-volatile memory (NVM) which stores information related to at least one of an amount of accumulated power or an accumulated driving time of an individual fuel cell stack.

As an exemplary embodiment of the present disclosure, when the driving of the fuel cell stack is ended, the first controller 110 may update information related to the at least one of the amount of accumulated power or the accumulated driving time of the individual fuel cell stack, which is stored in the NVM.

In the present process, when the driving of the fuel cell stack is ended, the first controller 110 may add an amount of power or a driving time of the individual fuel cell stack, which is in a recent driving process, to the amount of accumulated power or the accumulated driving time of the individual fuel cell stack, which is accumulated up to the previous driving process to update the information related to the amount of accumulated power or the accumulated driving time of the individual fuel cell stack, which is stored in the NVM.

As an exemplary embodiment of the present disclosure, in a process of monitoring the accumulated driving time of each individual fuel cell stack, the first controller 110 may integrate the driving time without change or may integrate the driving time by applying a weight to the driving time by multiplying the driving time by a factor according to power.

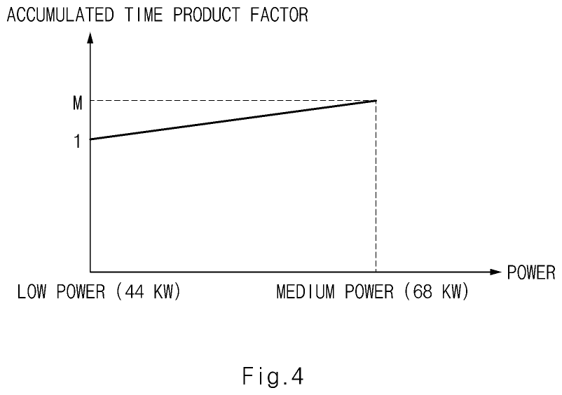

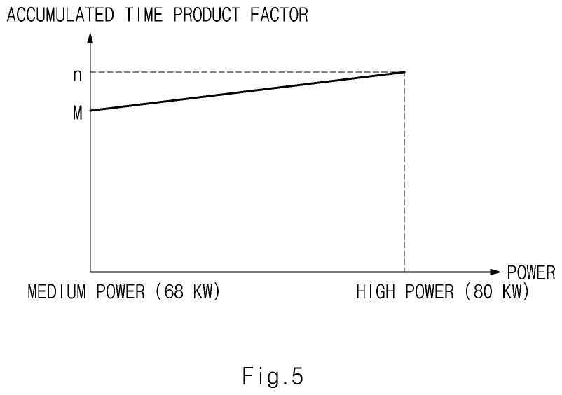

The case where the first controller 110 integrates the driving time by applying the weight to the driving time by multiplying the driving time by the factor according to the power will be described in detail with reference to FIG. 4 and FIG. 5.

FIG. 4 and FIG. 5 are drawings illustrating an accumulated time product factor according to power of a fuel cell stack according to an exemplary embodiment of the present disclosure.

In a process of monitoring an accumulated driving time of each individual fuel cell stack or a continuous driving time of each individual fuel cell stack, a fuel cell system control apparatus may integrate a driving time by applying a weight to the driving time by multiplying the driving time by a factor according to power.

As an exemplary embodiment of the present disclosure, when the power of each individual fuel cell stack is low power (e.g., 44 kW) corresponding to a low power level or is power less than or equal to the low power (e.g., 44 kW), the fuel cell system control apparatus may integrate the driving time using an accumulated time product factor according to power, which is “1”.

As an exemplary embodiment of the present disclosure, when the power of each individual fuel cell stack is medium power (e.g., 68 kW) corresponding to a medium power level, the fuel cell system control apparatus may integrate the driving time using an accumulated time product factor according to power, which is a value M greater than “1”.

As an exemplary embodiment of the present disclosure, when the power of each individual fuel cell stack is a value between the low power (e.g., 44 kW) and the medium power (e.g., 68 kW), the fuel cell system control apparatus may determine an accumulated time product factor ((M−1)/(medium power−low power), for example, (M−1)/24) having a linear value depending on power between the low power (e.g., 44 kW) and the medium power (e.g., 68 kW) and may integrate the driving time by applying a weight to the driving time by multiplying the driving time by the determined accumulated time product factor.

As an exemplary embodiment of the present disclosure, when the power of each individual fuel cell stack is high power (e.g., 80 kW) corresponding to a high power level, the fuel cell system control apparatus may integrate the driving time using an accumulated time product factor according to power, which is a value n greater than the accumulated time product factor M corresponding to the medium power.

As an exemplary embodiment of the present disclosure, when the power of each individual fuel cell stack is a value between the medium power (e.g., 68 kW) and the high power (e.g., 80 kW), the fuel cell system control apparatus may determine an accumulated time product factor ((n−M)/(high power−medium power), for example, (n−m)/12) having a linear value depending on power between the medium power (e.g., 68 kW) and the high power (e.g., 80 kW) and may integrate the driving time by applying a weight to the driving time by multiplying the driving time to the determined accumulated time product factor.

However, the case where the accumulated time product factor according to the power is linearly determined for the power between the low power and the medium power or the power between the medium power and the high power is only an example. The accumulated time product factor may be determined in various manners.

Return to FIG. 1, the first controller 110 will continue to be described. As an exemplary embodiment of the present disclosure, the first controller 110 may determine at least one of an amount of accumulated power or an accumulated driving time of the individual fuel cell stack in real time, by the information related to the at least one of the amount of accumulated power or the accumulated driving time of the individual fuel cell stack, which is stored in the NVM and is accumulated up to the previous driving process, and the at least one of the amount of power or the driving time of the individual fuel cell stack, which is measured in real time.

As an exemplary embodiment of the present disclosure, the first controller 110 may individually monitor a time when one or more fuel cell stacks are continuously driven or an amount of power continuously output by the one more fuel cell stacks in real time.

As an exemplary embodiment of the present disclosure, the first controller 110 may individually monitor a time when the individual fuel cell stack is continuously driven in the current driving process of the individual fuel cell stack or an amount of power continuously output by the individual fuel cell stack in the current driving process of the individual fuel cell stack, without considering the accumulated driving time of the individual fuel cell stack, which is accumulated up to the previous driving process.

Even in the process, the first controller 110 may integrate the driving time without change or may integrate the driving time by applying a weight to the driving time by multiplying the driving time by a factor according to power, in a process of monitoring a continuous driving time of each individual fuel cell stack.

As an exemplary embodiment of the present disclosure, the first controller 110 may be connected to the second controller 120 through wireless or wired communication to deliver the information related to the at least one of the amount of accumulated power or the accumulated driving time of the one or more fuel cell stacks or the information related to the time when the one or more fuel cell stacks are continuously driven or the amount of power continuously output by the one or more fuel cell stacks to the second controller 120 in real time.

The second controller 120 may control power of the one or more fuel cell stacks, based on the amount of monitored individual accumulated power or the monitored accumulated driving time of the one or more fuel cell stacks depending on the required power.

As an exemplary embodiment of the present disclosure, the second controller 120 may control the number of one or more driving fuel cell stacks, power of the one or more fuel cell stacks, and replacement of the one or more fuel cell stacks.

Herein, the number of the one or more driving fuel cell stacks may refer to the number of fuel cell stacks to be driven actually and output power among the one or more fuel cell stacks.

Herein, the replacement of the one or more fuel cell stacks may refer to stopping driving a fuel cell stack which is driving among the one or more fuel cell stacks and driving another fuel cell stack rather than the stopped fuel cell stack to generate power.

As an exemplary embodiment of the present disclosure, the second controller 120 may determine a power level of each of the one or more fuel cell stacks, based on the required power and the total number of drivable fuel cell stacks among the one or more fuel cell stacks.

In detail, the second controller 120 may determine the power level of each of the one or more fuel cell stacks among one or more power levels, based on the required power and the total number of drivable fuel cell stacks among the one or more fuel cell stacks.

Illustratively, the second controller 120 may determine the power level of each of the one or more fuel cell stacks among a low power level, a medium power level, and a high power level.

As an exemplary embodiment of the present disclosure, the second controller 120 may determine the power level of each of the one or more fuel cell stacks, based on whether a value obtained by dividing the required power by power corresponding to each power level is greater than the total number of drivable fuel cell stacks.

As an exemplary embodiment of the present disclosure, the second controller 120 may identify whether the value obtained by dividing the required power by the power corresponding to each power level, which is sequentially from a higher level, among the one or more power levels is greater than the total number of drivable fuel cell stacks.

In a process of identifying whether the value obtained by dividing the required power by the power corresponding to each power level, which is sequentially from the higher level, is greater than the total number of drivable fuel cell stacks, the second controller 120 may determine a power level, in which the value obtained by dividing the required power by the power corresponding to the power level is greater than the total number of the drivable fuel cell stacks for the first time, as the power level of each of the one or more fuel cell stacks.

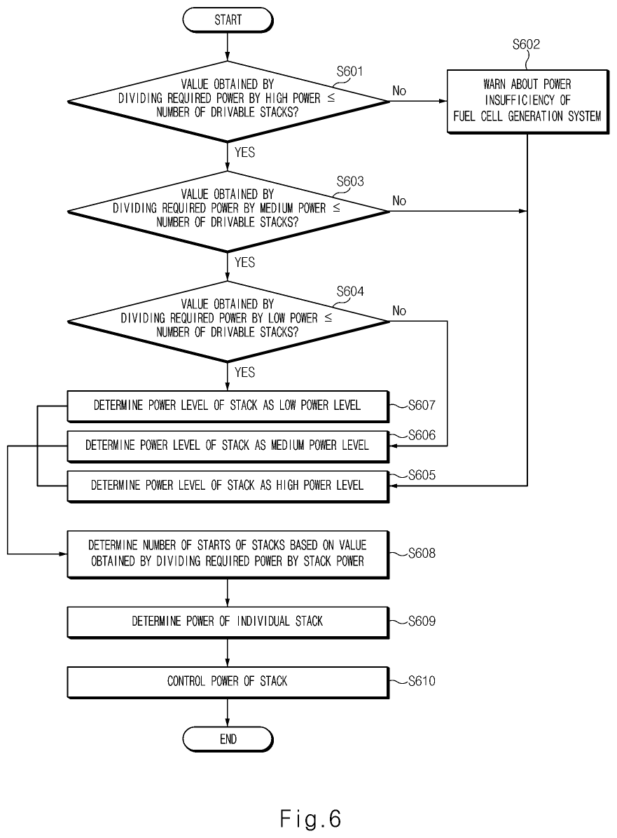

The contents where the second controller 120 determines the power level of each of the one or more fuel cell stacks will be described in detail with reference to FIG. 6.

FIG. 6 is a flowchart illustrating that a fuel cell system control apparatus is configured to determine the number of starts of a fuel cell stack and power of the fuel cell stack according to an exemplary embodiment of the present disclosure.

Referring to FIG. 6, in operation 601, the fuel cell system control apparatus may identify whether a value obtained by dividing required power by high power is less than or equal to the number of drivable fuel cell stacks.

As an exemplary embodiment of the present disclosure, the fuel cell system control apparatus may monitor whether it is impossible to drive each fuel cell stack as deterioration or failure occurs in each fuel cell stack and may identify the number of currently drivable fuel cell stacks.

Furthermore, the fuel cell system control apparatus may receive required power from at least one of a motor or the other auxiliary machinery.

When the value obtained by dividing the required power by the high power is not less than or equal to the number of the drivable fuel cell systems, in operation 602, the fuel cell system control apparatus may output a warning that the power of a fuel cell generation system is insufficient. In operation 605, the fuel cell system control apparatus may determine a power level of the fuel cell stack as a high power level.

When the value obtained by dividing the required power by the high power is less than or equal to the number of the drivable fuel cell stacks, in operation 603, the fuel cell system control apparatus may identify whether a value obtained by dividing the required power by medium power is less than or equal to the number of the drivable fuel cell stacks.

When the value obtained by dividing the required power by the medium power is not less than or equal to the number of the drivable fuel cell stacks, in operation 605, the fuel cell system control apparatus may determine the power level of the fuel cell stack as the high power level.

When the value obtained by dividing the required power by the medium power is less than or equal to the number of the drivable fuel cell stacks, in operation 604, the fuel cell system control apparatus may identify whether a value obtained by dividing the required power by low power is less than or equal to the number of the drivable fuel cell stacks.

When the value obtained by dividing the required power by the low power is not less than or equal to the number of the drivable fuel cell stacks, in operation 606, the fuel cell system control apparatus may determine a power level of the fuel cell stack as a medium power level.

When the value obtained by dividing the required power by the low power is less than or equal to the number of the drivable fuel cell stacks, in operation 607, the fuel cell system control apparatus may determine a power level of the fuel cell stack as a low power level.

Returning to FIG. 1, the second controller 120 will continue to be described. As an exemplary embodiment of the present disclosure, the second controller 120 may apply hysteresis to the required power or the total number of the drivable fuel cell stacks to determine a power level of each of the one or more fuel cell stacks.

As an exemplary embodiment of the present disclosure, to prevent the power level from being easily changed as the required power or the total number of the drivable fuel cell stacks is changed in real time, after the power level is determined for the first time, the second controller 120 may apply the hysteresis to the required power or the total number of the drivable fuel cell stacks to determine the power level of each of the one or more fuel cell stacks in real time.

As an exemplary embodiment of the present disclosure, the second controller 120 may apply a time delay to the required power or the total number of the drivable fuel cell stacks, which is changed in real time, or may apply the hysteresis to the required power or the total number of the drivable fuel cell stacks to adjust a boundary value in which the power level is changed to determine the power level of each of the one or more fuel cell stacks in real time.

As an exemplary embodiment of the present disclosure, the second controller 120 may determine the number of one or more driving fuel cell stacks, based on whether a value obtained by dividing the required power by power corresponding to the determined power level.

As an exemplary embodiment of the present disclosure, the second controller 120 may determine an integer part of the value obtained by dividing the required power by the power corresponding to the determined power level or a value obtained by adding “1” to the integer part of the value obtained by dividing the required power by the power corresponding to the determined power level as the number of the one or more driving fuel cell stacks.

The contents where the second controller 120 determines the number of the one or more driving fuel cell stacks will be described in detail with reference to FIG. 6.

As described above, FIG. 6 is a flowchart illustrating that a fuel cell system control apparatus is configured to determine the number of starts of a fuel cell stack and power of the fuel cell stack according to an exemplary embodiment of the present disclosure.

Referring to FIG. 6, in operation 608, the fuel cell system control apparatus may determine the number of starts of a fuel cell stack, based on the value obtained by dividing the required power by the power corresponding to the power level of the fuel cell stack.

As an exemplary embodiment of the present disclosure, power corresponding to a low power level may be 44 kW, power corresponding to a medium power level may be 68 kW, and power corresponding to a high power level may be 80 kW.

As an exemplary embodiment of the present disclosure, when the power level of the fuel cell stack is determined as the high power level, the fuel cell system control apparatus may determine an integer part of a value obtained by dividing required power by power corresponding to the high power level as the number of starts of the fuel cell stack.

However, in the present process, the integer part of the value obtained by dividing the required power by the power corresponding to the high power level may not be greater than the number of drivable fuel cell stacks.

As an exemplary embodiment of the present disclosure, when the power level of the fuel cell stack is determined as the medium power level and when a fractional part of a value obtained by dividing the required power by power corresponding to the medium power level is less than a value obtained by dividing a value obtained by subtracting medium power from high power by the medium power, the fuel cell system control apparatus may determine an integer part of the value obtained by dividing the required power by the power corresponding to the medium power level as the number of starts of the fuel cell stack.

As an exemplary embodiment of the present disclosure, when the power level of the fuel cell stack is determined as the medium power level and when the fractional part of the value obtained by dividing the required power by the power corresponding to the medium power level is not less than the value obtained by dividing the value obtained by subtracting the medium power from the high power by the medium power, the fuel cell system control apparatus may determine a value obtained by adding “1” to the integer part of the value obtained by dividing the required power by the power corresponding to the medium power level as the number of starts of the fuel cell stack.

When power of the remaining driven fuel cell stacks except for one representative fuel cell stack is determined as medium power and when the power of the representative fuel cell stack is determined as the remaining power, this is to prevent the power of the representative fuel cell stack from being greater than or equal to the high power.

As an exemplary embodiment of the present disclosure, when the power level of the fuel cell stack is determined as the low power level and when a fractional part of a value obtained by dividing the required power by power corresponding to the low power level is less than a value obtained by dividing a value obtained by subtracting low power from medium power by the low power, the fuel cell system control apparatus may determine an integer part of the value obtained by dividing the required power by the power corresponding to the low power level as the number of starts of the fuel cell stack.

As an exemplary embodiment of the present disclosure, when the power level of the fuel cell stack is determined as the low power level and when the fractional part of the value obtained by dividing the required power by the power corresponding to the low power level is not less than the value obtained by dividing the value obtained by subtracting the low power from the medium power by the medium power, the fuel cell system control apparatus may determine a value obtained by adding “1” to the integer part of the value obtained by dividing the required power by the power corresponding to the low power level as the number of starts of the fuel cell stack.

In operation 609, the fuel cell system control apparatus may determine power of an individual fuel cell stack.

As an exemplary embodiment of the present disclosure, the fuel cell system control apparatus may select a specific number of fuel cell stacks with a shortest accumulated driving time or a smallest amount of accumulated power as the representative fuel cell stack.

As an exemplary embodiment of the present disclosure, the fuel cell system control apparatus may determine the power of the remaining driven fuel cell stacks except for one or more representative fuel cell stacks as power corresponding to the determined power level.

As an exemplary embodiment of the present disclosure, the fuel cell system control apparatus may determine the power of each of the representative fuel cell stacks as a value obtained by dividing a value obtained by subtracting a value obtained by multiplying the number of the remaining driven fuel cell stacks except for the representative fuel cell stacks by the power corresponding to the determined power level from the required power by the number of the representative fuel cell stacks.

As an exemplary embodiment of the present disclosure, the fuel cell system control apparatus may determine whether the required power is greater than predetermined reference power (e.g., 30 kW) and may generate the required power by the fuel cell stack with a longest accumulated driving time or a largest amount of accumulated power, when the required power is not greater than the predetermined reference power.

In S610, the fuel cell system control apparatus may control the power of the fuel cell stack.

As an exemplary embodiment of the present disclosure, the fuel cell system control apparatus may control an ON/OFF sequence of the fuel cell stack to control the power of the fuel cell stack, based on the number of the determined starts of the fuel cell stack and the determined power of the fuel cell stack.

Returning again to FIG. 1, the second controller 120 will continue to be described. As an exemplary embodiment of the present disclosure, the second controller 120 may determine whether the time when each of the one or more fuel cell stacks is continuously driven or the amount of power continuously output by each of the one more fuel cell stacks is greater than a threshold time or a threshold amount of power corresponding to power of each of the one or more fuel cell stacks.

The second controller 120 may stop driving a fuel cell stack, a continuously driven time or an amount of continuously output power of which is greater than the threshold time or the threshold amount of power or may decrease power of the fuel cell stack, the continuously driven time or the amount of continuously output power of which is greater than the threshold time or the threshold amount of power.

The second controller 120 may drive another fuel cell stack to replace the fuel cell stack, the continuously drive time or the amount of continuously output power of which is greater than the threshold time or the threshold amount of power, and may increase power of the other fuel cell stack.

The second controller 120 may replace the fuel cell stack, the continuously driven time of which is greater than the threshold time or the amount of continuously output power of which is greater than the threshold amount of power, with another fuel cell stack and may drive the other fuel cell stack, thus preventing one or more fuel cell stacks from being degraded due to long-term use of the one or more fuel cell stacks and relatively uniformly managing an output time and an end of life (EOL) arrival time of each of the one or more fuel cell stacks.

As an exemplary embodiment of the present disclosure, the second controller 120 may determine priorities of other fuel cell stacks to select a fuel cell stack to replace the fuel cell stack, the continuously driven time of which is greater than the threshold time or the amount of continuously output power of which is greater than the threshold amount of power, among the other fuel cell stacks.

As an exemplary embodiment of the present disclosure, the second controller 120 may determine the priorities of the other fuel cell stacks based on the amount of accumulated power or the accumulated driving time. The second controller 120 may assign a high priority to a fuel cell stack with a small amount of accumulated power or a short accumulated driving time.

As an exemplary embodiment of the present disclosure, the fuel cell stack with the small amount of accumulated power or the short accumulated driving time is a fuel cell stack with the highest priority. The second controller 120 may replace the fuel cell stack, the continuously driven time of which is greater than the threshold time or the amount of continuously output power of which is greater than the threshold amount of power, with a fuel cell stack with a smallest amount of accumulated power or a shortest accumulated driving time among the one or more fuel cell stacks.

As an exemplary embodiment of the present disclosure, the second controller 120 may determine the fuel cell stack with the smallest amount of accumulated power or the shortest accumulated driving time in real time among the one or more fuel cell stacks and may determine power of each of the remaining driven fuel cell stacks except for the fuel cell stack with the smallest amount of accumulated power or the shortest accumulated driving time, based on the power corresponding to the determined power level.

Power corresponding to the one or more power levels may be preset.

Illustratively, power corresponding to the low power level may be set to 44 kW, power corresponding to the medium power level may be set to 68 kW, and power corresponding to the high power level may be set to 80 kW.

As an exemplary embodiment of the present disclosure, the second controller 120 may select the fuel cell stack with the smallest amount of accumulated power or the shortest accumulated driving time as a representative fuel cell stack to relatively uniformly manage an amount of accumulated power or an accumulated driving time of the one or more fuel cell stacks and may adjust power of the representative fuel cell stack to be greater than power of another driven fuel cell stack.

As an exemplary embodiment of the present disclosure, the second controller 120 may uniformly set power of other driven fuel cell stacks except for the representative fuel cell stack and may output remaining power up to the required power by one or more representative fuel cell stacks.

Herein, the second controller 120 may determine the number of representative fuel cell stacks, based on the required power, the number of one or more driving fuel cell stacks, the power corresponding to the determined power level, and power corresponding to a power level which is one step higher than the determined power level.

As an exemplary embodiment of the present disclosure, the second controller 120 may determine the number of representative fuel cell stacks using Equation 1 below.

$$number of representative stacks = integer part \{ \frac{required power - ( power of determined power level ) \times ( number of \text{?}}{( power of power level one step higher than determined power level ) - ( power \text{?}} + 1 \qquad [ Equation 1 ]$$

$$\text{?} \text{indicates text missing or illegible when filed}$$

Illustratively, when the determined power level is the low power level, the power of the power level which is one step higher than the determined power level may be power of the medium power level, “68 kW”.

Illustratively, when the determined power level is the medium power level, the power of the power level which is one step higher than the determined power level may be power of the high power level, “80 kW”.

As an exemplary embodiment of the present disclosure, the second controller 120 may determine power of the representative fuel cell stack, based on a value obtained by subtracting the sum of power of the remaining fuel cell stacks except for the representative fuel cell stack from the required power.

As an exemplary embodiment of the present disclosure, the second controller 120 may determine a value, obtained by dividing the value obtained by subtracting the sum of the power of the remaining fuel cell stacks except for the representative fuel cell stacks from the required power by the number of the representative fuel cell stacks, as the power of the representative fuel cell stacks.

The contents where the second controller 120 determines the power of each of the one or more fuel cell stacks are described above with reference to FIG. 6.

As an exemplary embodiment of the present disclosure, when the required power is greater than a value obtained by multiplying the total number of drivable fuel cell stacks among the one or more fuel cell stacks by power corresponding to the highest power level, the second controller 120 may generate remaining power by a separate high voltage battery.

As an exemplary embodiment of the present disclosure, when there is a high voltage battery included in the fuel cell system or connected to the fuel cell system, the second controller 120 may generate remaining power by the separate high voltage battery.

As an exemplary embodiment of the present disclosure, when the one or more fuel cell stacks have maximum power higher than the power corresponding to the highest power level and when the required power is less than a value obtained by multiplying the total number of drivable fuel cell stacks among the one or more fuel cell stacks by the maximum power, the second controller 120 may generate all of the required power by the drivable fuel cell stacks.

As an exemplary embodiment of the present disclosure, when there is no high voltage battery included in the fuel cell system or connected to the fuel cell system and when the required power is greater than the value obtained by multiplying the total number of the drivable fuel cell stacks among the one or more fuel cell stacks by the maximum power, the second controller 120 may generate maximum power configured for being generated by the drivable fuel cell stacks, without using a separate high voltage battery.

Although not illustrated, as an exemplary embodiment of the present disclosure, the fuel cell system control apparatus 100 may further include an output device which outputs a warning about power insufficiency of the fuel cell system, when the required power is greater than the value obtained by multiplying the total number of the drivable fuel cell stacks among the one or more fuel cell stacks by the power corresponding to the highest power level.

As an exemplary embodiment of the present disclosure, when the fuel cell system is provided in a vehicle, the output device may output a warning about the power insufficiency of the system by a display included in an audio, video, navigation (AVN), a cluster, a head-up display (HUD), or the like of the vehicle.

As an exemplary embodiment of the present disclosure, the output device may output a warning about the power insufficiency of the system by a visual or audible signal.

As an exemplary embodiment of the present disclosure, the second controller 120 may determine whether the required power is greater than predetermined reference power and may generate the required power by the fuel cell stack with the largest amount of accumulated power or the longest accumulated driving time, when the required power is not greater than the predetermined reference power.

As an exemplary embodiment of the present disclosure, the predetermined reference power may be determined to be the same as or less than power corresponding to the lowest power level among one or more power levels.

Illustratively, the predetermined reference power may be determined as 30 kW.

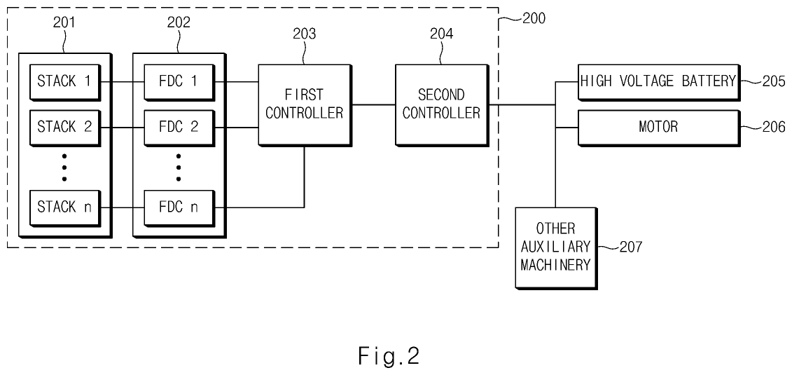

FIG. 2 is a drawing illustrating a detailed configuration of a fuel cell system according to an exemplary embodiment of the present disclosure.

Referring to FIG. 2, a fuel cell system 200 may include one or more fuel cell stacks 201, one or more fuel-cell DC-DC converter (FDCs) 202, a first controller 203, and a second controller 204.

Furthermore, the fuel cell system 200 may be connected to a high voltage battery 205, a motor 206, and other auxiliary machinery 207 provided in the vehicle. As an exemplary embodiment of the present disclosure, as shown in FIG. 2, the fuel cell system 200 may be connected to the high voltage battery 205, the motor 206, and the other auxiliary machinery 207 through the second controller 204.

The one or more fuel cell stacks 201 may generate power to be supplied to the motor 206 and the other auxiliary machinery 207 of the vehicle.

The respective fuel cell stacks 201 may be connected to the FDCs 202 respectively corresponding to the respective fuel cell stacks 201.

Each of the FDCs 202 may boost or buck a voltage of power generated by the fuel cell stack 201 to drive the motor 206 or charge the high voltage battery 205 using the power with the boosted voltage.

Furthermore, each of the FDCs 202 may control a current and voltage of each of the fuel cell stacks 201 to control the amount of power production of the individual fuel cell stacks 201.

The first controller 203 may be connected to the one or more FDCs 202, which may include one or more processors which perform data processing and a command.

As an exemplary embodiment of the present disclosure, the first controller 203 may include an FCU.

The first controller 203 may monitor or diagnose a state, such as whether it is possible for the one or more fuel cell stacks 201 to be driven, power of each of the one or more fuel cell stacks 201, or a driving time of each of the one or more fuel cell stacks 201, by the one or more FDCs 202.

The second controller 204 may control power of each of the one or more fuel cell stack 201 depending on the state of each of the one or more fuel cell stack 201, which is monitored or diagnosed by the first controller 203.

The second controller 204 may be connected to the first controller 203, the motor 206 of the vehicle, and the other auxiliary machinery 207 of the vehicle.

The second controller 204 may be connected to the one or more first controllers 203 to control a total amount of power production produced by the one or more fuel cell stack 201.

Furthermore, the second controller 204 may control distribution of the produced power.

As an exemplary embodiment of the present disclosure, a fuel cell system control apparatus 100 of FIG. 1 may be the concept including the first controller 203 and the second controller 204 of FIG. 2.

Power required for the fuel cell system 200 may include power for driving the motor 206.

The other auxiliary machinery 207 may include an air compressor, a humidifier, a cathode oxygen depletion (COD) heater, a coolant pump, or the like of the vehicle.

Power should be able to be supplied to the motor 206 and the other auxiliary machinery 207 by power generated by the fuel cell stacks 201 and the high voltage battery 205.

Thus, power generated by the fuel cell stacks 201 and the high voltage battery 205 should be able to be greater than or equal to power required in the motor 206 and the other auxiliary machinery 207. To the present end, the fuel cell system 200 may control production and distribution of the required power by the first controller 203 and the second controller 204.

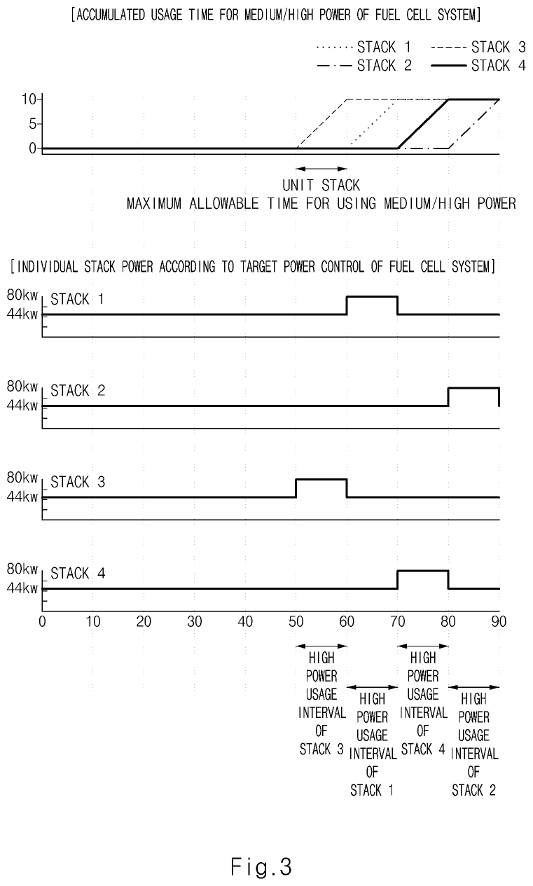

FIG. 3 is a drawing illustrating that a fuel cell system control apparatus replaces a fuel cell stack over a time when the fuel cell stack is continuously driven according to an exemplary embodiment of the present disclosure.

A graph indicating an accumulated usage time for medium power/high power of each fuel cell stack of a fuel cell system and a graph indicating power of an individual fuel cell stack of the fuel cell system are illustrated in FIG. 3.

An X-axis of the graph indicating the accumulated usage time for the medium power/high power of each fuel cell stack of the fuel cell system may refer to time, and a Y-axis of the graph may refer to the accumulated usage time.

An X-axis of the graph indicating the power of the individual fuel cell stack of the fuel cell system may refer to time, and a Y-axis of the graph may refer to power.

While stacks 1 to 4 generate power as low power (e.g., 44 kW) corresponding to a low power level, the accumulated usage time for medium power/high power may fail to be integrated. While stacks 1 to 4 generate power as high power (e.g., 80 kW) corresponding to a high power level, the accumulated usage time for medium power/high power may be integrated.

The fuel cell system control apparatus may monitor the accumulated usage time for medium power/high power in stacks 1 to 4 in real time.

Stack 3 may generate the high power (e.g., 80 kW) in an interval where time is 50 to 60. When the accumulated usage time for medium power/high power in stack 3 in the interval where the time is 50 to 60 is integrated to reach a predetermined threshold time (e.g., 10), the fuel cell system control apparatus may control power of stack 3 to the low power (e.g., 44 kW) again.

The fuel cell system control apparatus may control the power of stack 3 to the low power (e.g., 44 kW) at a time point when the time is 60 and may simultaneously control power of stack 1, which has a shortest accumulated driving time or a smallest amount of accumulated power to the high power (e.g., 80 kW) with respect to the time point when the time is 60, thus replacing the power of stack 3.

Stack 1 may generate the high power (e.g., 80 kW) in the interval where the time is 60 to 70. When the accumulated usage time for medium power/high power in stack 1 in the interval where the time is 60 to 70 is integrated to reach a predetermined threshold time (e.g., 10), the fuel cell system control apparatus may control power of stack 1 to the low power (e.g., 44 kW) again.

The fuel cell system control apparatus may control the power of stack 1 to the low power (e.g., 44 kW) at a time point when the time is 70 and may simultaneously control power of stack 4, which has the shortest accumulated driving time or the smallest amount of accumulated power to the high power (e.g., 80 kW) with respect to the time point when the time is 70, thus replacing the power of stack 1.

Stack 4 may generate the high power (e.g., 80 kW) in the interval where the time is 70 to 80. When the accumulated usage time for medium power/high power in stack 4 in the interval where the time is 70 to 80 is integrated to reach the predetermined threshold time (e.g., 10), the fuel cell system control apparatus may control power of stack 4 to the low power (e.g., 44 kW) again.

The fuel cell system control apparatus may control the power of stack 4 to the low power (e.g., 44 kW) at a time point when the time is 80 and may simultaneously control power of stack 2, which has the shortest accumulated driving time or the smallest amount of accumulated power to the high power (e.g., 80 kW) with respect to the time point when the time is 80, thus replacing the power of stack 4.

Stack 2 may generate the high power (e.g., 80 kW) in the interval where the time is 80 to 90.

The present drawing illustrates only the example of adjusting the power of the fuel cell stack depending on whether the continuously driven time is greater than the threshold time with respect to the four stacks. However, the number of stacks may be determined as another number and the fuel cell stack may be replaced according to whether the amount of power continuously output by the fuel cell stack is greater than the threshold amount of power. Furthermore, it may be replaced in a manner where the driving of the replaced fuel cell stack is stopped and where another fuel cell stack is newly driven.

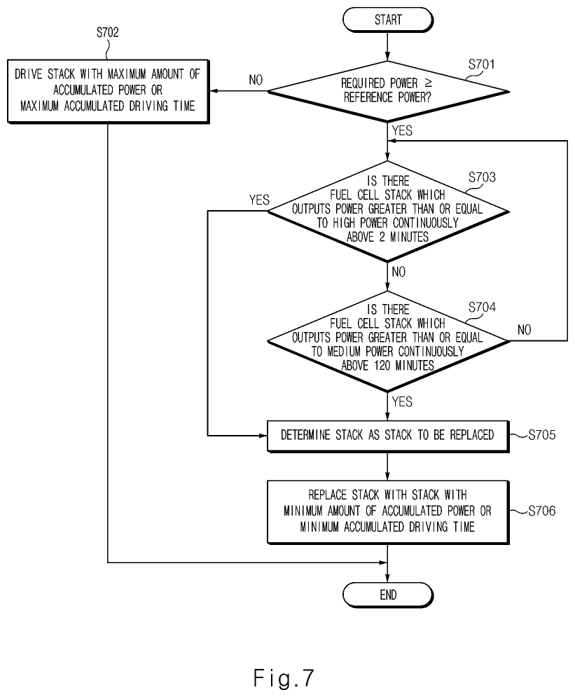

FIG. 7 is a flowchart illustrating that a fuel cell system control apparatus replaces a fuel cell stack according to an exemplary embodiment of the present disclosure;

Referring to FIG. 7, in operation 701, the fuel cell system control apparatus may identify whether required power is greater than or equal to reference power.

As an exemplary embodiment of the present disclosure, the reference power may be determined as a value less than power corresponding to a lowest power level among one or more power levels of a fuel cell stack.

As an exemplary embodiment of the present disclosure, the reference power may be determined as 30 kW.

When the required power is not greater than or equal to the reference power, in operation 702, the fuel cell system control apparatus may drive a fuel cell stack with a maximum amount of accumulated power or a maximum accumulated driving time.

As an exemplary embodiment of the present disclosure, when the required power is not greater than or equal to the reference power, the fuel cell system control apparatus may generate the required power by the fuel cell stack with the maximum accumulated driving time or the maximum amount of accumulated power.

When the required power is greater than or equal to the reference power, in operation 703, the fuel cell system control apparatus may identify whether there is a fuel cell stack which outputs power greater than or equal to high power continuously above 2 minutes.

Herein, the time “2 minutes” may be a value for giving an example, which may be actually determined as another value corresponding to the high power.

When it is identified that there is the fuel cell stack which outputs the power greater than or equal to the high power continuously above 2 minutes, in operation 705, the fuel cell system control apparatus may determine the fuel cell stack as a fuel cell stack to be replaced.

When it is identified that there is no fuel cell stack which outputs the power greater than or equal to the high power continuously above 2 minutes, in operation 704, the fuel cell system control apparatus may identify whether there is a fuel cell stack which outputs power greater than or equal to medium power continuously above 120 minutes.

Herein, the time “120 minutes” may be a value for giving an example, which may be actually determined as another value corresponding to the medium power.

When it is identified that there is no fuel cell stack which outputs the power greater than or equal to the medium power continuously above 120 minutes, the fuel cell system control apparatus may return to operation 703 to identify whether there is a fuel cell stack which outputs power greater than or equal to the high power continuously above 2 minutes.

A fuel cell stack, the power of which is less than the medium power, may continuously maintain the power, without replacement according to the continuously driven time or the amount of continuously output power.

When it is identified that there is the fuel cell stack which outputs the power greater than or equal to the medium power continuously above 120 minutes, in operation 705, the fuel cell system control apparatus may determine the fuel cell stack as a fuel cell stack to be replaced.

In operation 706, the fuel cell system control apparatus may replace the fuel cell stack with a stack with a minimum amount of accumulated power or a minimum accumulated driving time.

As an exemplary embodiment of the present disclosure, the fuel cell system control apparatus may decrease power of a fuel cell stack to be replaced and may increase power of a new fuel cell stack to replace the fuel cell stack to be replaced.

At the present time, the fuel cell system control apparatus may control power (a negative slew rate, for example, −30 kW/s) of a fuel cell stack to be replaced, which decreases per hour, and power (a positive slew rate, for example, 30 kW/s) of a new fuel cell stack to replace the fuel cell stack to be replaced, which increases per hour, to be the same in magnitude as each other and may always maintain the same total power even while it is replaced.

As an exemplary embodiment of the present disclosure, the fuel cell system control apparatus may determine a value by dividing a difference between the required power and power of the fuel cell stack to be replaced (or power of the fuel cell stack to replace) by a magnitude of the decreased (or increased) power.

As an exemplary embodiment of the present disclosure, when starting of the fuel cell stack to replace the fuel cell stack is already completed, the fuel cell system control apparatus may initiate to decrease power of the fuel cell stack to be replaced and increase power of the fuel cell stack to replace before a time (e.g., (required power−current power)/output increase slew rate) obtained by dividing a difference between the required power and the power of the fuel cell stack to replace by the magnitude of the power which increases per hour, with respect to a time point when it reaches a threshold time of the fuel cell stack to be replaced.

As an exemplary embodiment of the present disclosure, when the starting of the fuel cell stack to replace the fuel cell stack is not completed, the fuel cell system control apparatus may initiate to start the fuel cell stack to replace the fuel cell stack before a time obtained by adding a time necessary for the starting of the fuel cell stack to replace to the time (e.g., (required power−current power)/output increase slew rate) obtained by dividing the difference between the required power and the power of the fuel cell stack to replace by the magnitude of the power which increases per hour, with respect to the time point when it reaches the threshold time of the fuel cell stack to be replaced.

Illustratively, the time necessary for the starting of the fuel cell stack may be determined as 5 seconds.

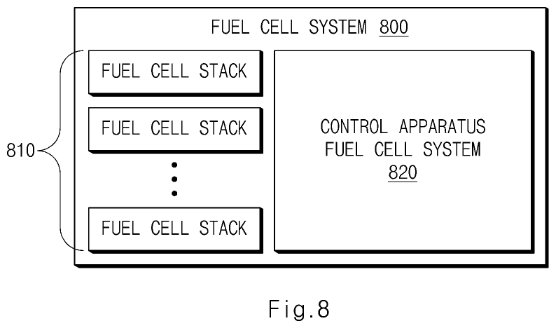

FIG. 8 is a block diagram illustrating a fuel cell system according to an exemplary embodiment of the present disclosure.

Referring to FIG. 8, a fuel cell system 800 may include one or more fuel cell stacks 810 and a fuel cell system control apparatus 820.

The one or more fuel cell stacks 810 may be provided in a vehicle to generate power of a motor or the like of the vehicle.

The fuel cell system control apparatus 820 may individually monitor at least one of an amount of accumulated power or an accumulated driving time of each of the one or more fuel cell stacks 810 and may control power each of the one or more fuel cell stacks 810, based on the amount of monitored individual accumulated power or the monitored individual accumulated driving time of each of the one or more fuel cell stacks 810 depending on the required power.

As an exemplary embodiment of the present disclosure, the fuel cell system control apparatus 820 may determine a power level of each of the one or more fuel cell stacks 810, based on required power and the total number of drivable fuel cell stacks among the one or more fuel cell stacks 810.

As an exemplary embodiment of the present disclosure, the fuel cell system control apparatus 820 may determine the power level of each of the one or more fuel cell stacks 810, based on whether a value obtained by dividing the required power by power corresponding to each power level is greater than the total number of drivable fuel cell stacks.

As an exemplary embodiment of the present disclosure, the fuel cell system control apparatus 820 may apply hysteresis to the required power and the total number of drivable fuel cell stacks to determine the power level of each of the one or more fuel cells.

As an exemplary embodiment of the present disclosure, the fuel cell system control apparatus 820 may determine the number of one or more driving fuel cell stacks, based on the value obtained by dividing the required power by the power corresponding to the determined power level.

As an exemplary embodiment of the present disclosure, the fuel cell system control apparatus 820 may individually monitor a time when the one or more fuel cell stacks 810 are continuously driven or an amount of power continuously output by the one or more fuel cell stacks 810 in real time, may determine whether the time when the one or more fuel cell stacks 810 are continuously driven or the amount of power continuously output by the one or more fuel cell stack 810 is greater than a threshold time or a threshold amount of power corresponding to power of each of the one or more fuel cell stacks 810, may stop driving a fuel cell stack, a continuously driven time or an amount of continuously output power of which is greater than the threshold time or the threshold amount of power, or may decrease power of the fuel cell stack, the continuously driven time or the amount of continuously output power of which is greater than the threshold time or the threshold amount of power, and may drive another fuel cell stack to replace the fuel cell stack, the continuously driven time or the amount of continuously output power of which is greater than the threshold time or the threshold amount of power or may increase power of the other fuel cell stack.

As an exemplary embodiment of the present disclosure, the fuel cell system control apparatus 820 may replace the fuel cell stack, the continuously driven time or the amount of continuously output power of which is greater than the threshold time or the threshold amount of power, with a fuel cell stack with a shortest accumulated driving time or a smallest amount of accumulated power among the one or more fuel cell stack 810.

As an exemplary embodiment of the present disclosure, the fuel cell system control apparatus 820 may determine fuel cell stacks with the smallest amount of accumulated power or the shortest accumulated driving time among the one or more fuel cell stacks 810 as representative fuel cell stacks in real time, may determine power of each of the remaining driven fuel cell stacks except for the representative fuel cell stacks, based on power corresponding to the determined power level, and may determine power of the representative fuel cell stacks, based on a value obtained by dividing a value obtained by subtracting the sum of the power of the remaining fuel cell stacks except for the representative fuel cell stacks from the required power by the number of the representative fuel cell stacks.

As an exemplary embodiment of the present disclosure, the fuel cell system 800 may further include a high voltage battery which generates remaining power, when the required power is greater than a value obtained by multiplying the total number of drivable fuel cell stacks among the one or more fuel cell stacks 810 by power corresponding to the highest power level.

As an exemplary embodiment of the present disclosure, when the required power is greater than the value obtained by multiplying the total number of the drivable fuel cell stacks among the one or more fuel cell stacks 810 by the power corresponding to the highest power level, the fuel cell system control apparatus 820 may output a warning about power insufficiency of the fuel cell system.

As an exemplary embodiment of the present disclosure, the fuel cell system control apparatus 820 may determine whether the required power is greater than predetermined reference power and may generate the required power by the fuel cell stack with the largest amount of accumulated power or the longest accumulated driving time, when the required power is not greater than the predetermined reference power.

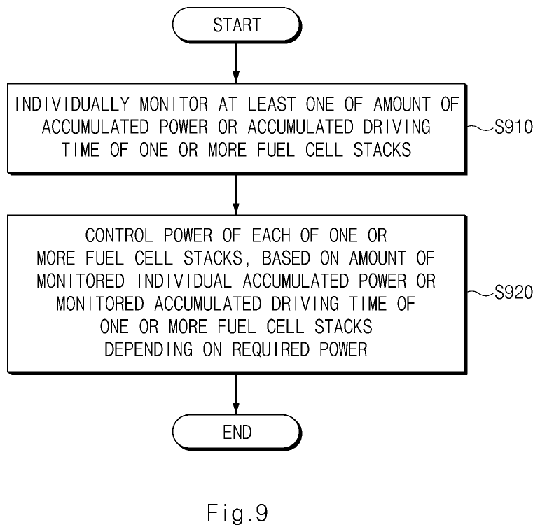

FIG. 9 is a flowchart illustrating a fuel cell system control method according to an exemplary embodiment of the present disclosure.

Referring to FIG. 9, the fuel cell system control method may include individually monitoring (910) at least one of an amount of accumulated power or an accumulated driving time of one or more fuel cell stacks and controlling (920) power of each of the one or more fuel cells, based on the amount of monitored individual accumulated power or the monitored individual accumulated driving time of the one or more fuel cell stacks, depending on the required power.

The individual monitoring (910) of the at least one of the amount of accumulated power or the accumulated driving time of the one or more fuel cell stacks may be performed by a first controller.

The controlling (920) of the power of each of the one or more fuel cell stacks, based on the amount of the monitored individual accumulated power or the monitored individual accumulated driving time of the one or more fuel cell stacks may be performed by a second controller.

As an exemplary embodiment of the present disclosure, the fuel cell system control method may further include determining, by the second controller, a power level of each of the one or more fuel cell stacks, based on the required power and the total number of drivable fuel cell stacks among the one or more fuel cell stacks.

As an exemplary embodiment of the present disclosure, the fuel cell system control method may further include determining, by the second controller, the number of one or more driving fuel cell stacks, based on a value obtained by dividing the required power by power corresponding to the determined power level.

As an exemplary embodiment of the present disclosure, the fuel cell system control method may further include applying, by the second controller, hysteresis to the required power and the total number of drivable fuel cell stacks to determine the power level of each of the one or more fuel cells.

As an exemplary embodiment of the present disclosure, the fuel cell system control method may further include determining, by the second controller, the number of one or more driving fuel cell stacks, based on the value obtained by dividing the required power by the power corresponding to the determined power level.

As an exemplary embodiment of the present disclosure, the fuel cell system control method may further include individually monitoring, by the first controller, a time when the one or more fuel cell stacks are continuously driven or an amount of power continuously output by the one more fuel cell stacks in real time.

As an exemplary embodiment of the present disclosure, the controlling (920) of the power of each of the one or more fuel cell stacks, based on the amount of monitored individual accumulated power or the monitored individual accumulated driving time of the one or more fuel cell stacks depending on the required power may include determining, by the second controller, whether the time when the one or more fuel cell stacks are continuously driven or the amount of power continuously output by the one or more fuel cell stack is greater than a threshold time or a threshold amount of power corresponding to power of each of the one or more fuel cell stacks, stopping driving a fuel cell stack, a continuously driven time or an amount of continuously output power of which is greater than the threshold time or the threshold amount of power, or decreasing power of the fuel cell stack, the continuously driven time or the amount of continuously output power of which is greater than the threshold time or the threshold amount of power, and driving, by the second controller, another fuel cell stack to replace the fuel cell stack, the continuously driven time or the amount of continuously output power of which is greater than the threshold time or the threshold amount of power, or increasing power of the other fuel cell stack.

As an exemplary embodiment of the present disclosure, the driving of the other fuel cell stack to replace the fuel cell stack, the continuously driven time or the amount of continuously output power of which is greater than the threshold time or the threshold amount of power, may include replacing, by the second controller, the fuel cell stack, the continuously driven time or the amount of continuously output power of which is greater than the threshold time or the threshold power amount, with a fuel cell stack with a shortest accumulated driving time or a smallest amount of accumulated power among the one or more fuel cell stacks.

As an exemplary embodiment of the present disclosure, the controlling (920) of the power of the one or more fuel cell stacks, based on the amount of monitored individual accumulated power or the monitored individual accumulated driving time of the one or more fuel cell stacks depending on the required power may include determining, by the second controller, a fuel cell stack with the smallest amount of accumulated power or the shortest accumulated driving time among the one or more fuel cell stacks in real time, determining, by the second controller, power of the remaining driven fuel cell stacks except for representative fuel cell stacks, based on power corresponding to the determined power level, and determining, by the second controller, power of the representative fuel cell stacks, based on a value obtained by dividing a value obtained by subtracting the sum of the remaining fuel cell stacks except for the representative fuel cell stacks from the required power by the number of the representative fuel cell stacks.

As an exemplary embodiment of the present disclosure, the fuel cell system control method may further include generating, by the second controller, remaining power by a separate high voltage battery, when the required power is greater than a value obtained by multiplying the total number of drivable fuel cell stacks among the one or more fuel cell stacks by power corresponding to a highest power level.

As an exemplary embodiment of the present disclosure, the fuel cell system control method may further include outputting, by the second controller, a warning about power insufficiency of the fuel cell system by an output device, when the required power is greater than the value obtained by multiplying the total number of the drivable fuel cell stacks among the one or more fuel cell stacks by the power corresponding to the highest power level.

As an exemplary embodiment of the present disclosure, the controlling (920) of the power of each of the one or more fuel cell stacks, based on the amount of the monitored individual accumulated power or the monitored individual accumulated driving time of the one or more fuel cell stacks may include determining, by the second controller, whether the required power is greater than predetermined reference power and generating, by the second controller, the required power by a fuel cell stack with the largest amount of accumulated power or the longest accumulated driving time among the one or more fuel cell stacks, when the required power is not greater than the predetermined reference power.

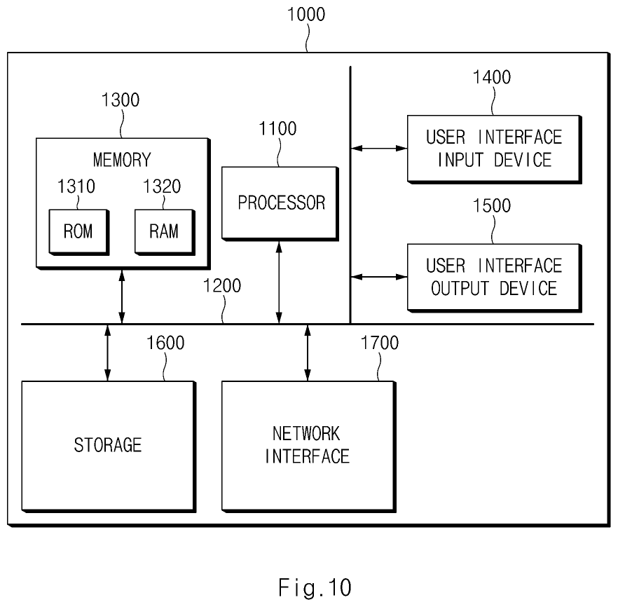

FIG. 10 illustrates a computing system according to an exemplary embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the fuel cell system control apparatus, the system including the same, and the method thereof according to various exemplary embodiments of the present disclosure.

According to at least one of embodiments of the present disclosure, the apparatus, the system including the same, and the method thereof may be provided to control a multi-module fuel cell system.

Furthermore, according to at least one of embodiments of the present disclosure, the fuel cell system control apparatus, the system including the same, and the method thereof are provided to ensure stack durability by controlling distribution of fuel cell stacks.

Furthermore, according to at least one of embodiments of the present disclosure, the fuel cell system control apparatus, the system including the same, and the method thereof are provided to prevent stack power from being degraded by diagnosing and monitoring stacks and schedule power of the stacks.

Furthermore, according to at least one of embodiments of the present disclosure, the fuel cell system control apparatus, the system including the same, and the method thereof are provided to address a problem in which power of a fuel cell system is degraded when irreversible deterioration or failure occurs in some fuel cell stacks.

Furthermore, according to at least one of embodiments of the present disclosure, the fuel cell system control apparatus, the system including the same, and the method thereof are provided to address a problem in which the sum of power of individual stacks upon minimum power control due to characteristics of the multi-module fuel cell system.

Furthermore, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell system control apparatus, comprising:
a first controller configured to monitor at least one of an amount of accumulated power or an accumulated driving time of a plurality of fuel cell stacks; and
a second controller configured to control power of each of the fuel cell stacks, based on the amount of monitored accumulated power or the monitored accumulated driving time of the plurality of fuel cell stacks depending on required power.

2. The fuel cell system control apparatus of claim 1, wherein the second controller is configured to determine a power level of each of the fuel cell stacks, based on the required power and a number of drivable fuel cell stacks among the plurality of fuel cell stacks, and
determine the power level of each of the fuel cell stacks, based on whether a value obtained by dividing the required power by power corresponding to each power level is greater than the number of drivable fuel cell stacks among the plurality of fuel cell stacks.

3. The fuel cell system control apparatus of claim 2, wherein the second controller is configured to determine the number of driving fuel cell stacks, based on a value obtained by dividing the required power by power corresponding to the determined power level.

4. The fuel cell system control apparatus of claim 1, wherein the second controller is configured to stop driving a fuel cell stack, a continuously driven time or an amount of continuously output power of which is greater than a threshold time or a threshold amount of power corresponding to the power of each of the fuel cell stack, or to decrease power of the fuel cell stack.

5. The fuel cell system control apparatus of claim 1, wherein the second controller is configured to drive another fuel cell stack to replace a fuel cell stack, a continuously driven time or an amount of continuously output power of which is greater than a threshold time or a threshold amount of power corresponding to the power of each of the fuel cell stack, or to increases power of the other fuel cell stack.

6. The fuel cell system control apparatus of claim 3, wherein the second controller is configured to replace a fuel cell stack, a continuously driven time or an amount of continuously output power of which is greater than a threshold time or a threshold amount of power corresponding to the power of each of the fuel cell stack, with a fuel cell stack with a shortest accumulated driving time or a smallest amount of accumulated power among the plurality of fuel cell stacks, and
determine a number of representative fuel cell stacks with a smallest amount of accumulated power or a shortest accumulated driving time among the plurality of fuel cell stacks, based on the required power, the number of the driving fuel cell stacks, the power corresponding to the determined power level, and power corresponding to a power level which is one step higher than the determined power level.

7. The fuel cell system control apparatus of claim 2, wherein the second controller is configured to determine fuel cell stacks with a smallest amount of accumulated power or a shortest accumulated driving time among the plurality of fuel cell stacks as representative fuel cell stacks and to determine power of each of remaining driven fuel cell stacks except for the representative fuel cell stacks, based on power corresponding to the determined power level.

8. The fuel cell system control apparatus of claim 7, wherein the second controller is configured to determine power of the representative fuel cell stacks, based on a value obtained by dividing a value obtained by subtracting a sum of the power of the remaining driven fuel cell stacks except for the representative fuel cell stacks from the required power by the number of the representative fuel cell stacks.

9. The fuel cell system control apparatus of claim 1, wherein the second controller is configured to generate remaining power by a separate high voltage battery, when the required power is greater than a value obtained by multiplying a total number of drivable fuel cell stacks among the plurality of fuel cell stacks by power corresponding to a highest power level.

10. The fuel cell system control apparatus of claim 1, wherein the second controller is configured to determine whether the required power is greater than or equal to predetermined reference power and to generate the required power by a fuel cell stack with a largest amount of accumulated power or a longest accumulated driving time among the plurality of fuel cell stack, when the required power is not greater than or equal to the predetermined reference power.

11. The fuel cell system control apparatus of claim 1, wherein the second controller is configured to determine whether the required power is greater than or equal to predetermined reference power and to determine a fuel cell stack to be replaced, based on whether there is a fuel cell stack which outputs power corresponding to a highest power level continuously above a predetermined first reference time or whether there is a fuel cell stack which outputs power corresponding to a power level which is one step lower than the highest power level continuously above a predetermined second reference time, when the required power is greater than or equal to the predetermined reference power.

12. The fuel cell system control apparatus of claim 11, wherein the second controller is configured to replace the fuel cell stack to be replaced with a fuel cell stack with a smallest amount of accumulated power or a shortest accumulated driving time among the plurality of fuel cell stacks.

13. The fuel cell system control apparatus of claim 11, wherein the second controller is configured to initiate to start the fuel cell stack to be replaced before a time obtained by adding a time necessary to start the fuel cell stack to be replaced to a time corresponding to the value obtained by dividing the difference between the required power and the power of the fuel cell stack to replace the fuel cell stack to be replaced by the magnitude of the power increasing per hour, when starting of the fuel cell stack to replace the fuel cell stack is not already completed.

14. A fuel cell system, comprising:
a plurality of fuel cell stacks; and
a fuel cell system control apparatus configured to monitor at least one of an amount of accumulated power or an accumulated driving time of the plurality of fuel cell stacks and to control power of each of the fuel cell stacks, based on the amount of monitored accumulated power or the monitored accumulated driving time of the plurality of fuel cell stacks depending on required power.

15. A fuel cell system control method, comprising:
monitoring, by a first controller, at least one of an amount of accumulated power or an accumulated driving time of a plurality of fuel cell stacks; and
controlling, by a second controller, power of each of the fuel cell stacks, based on the amount of monitored accumulated power or the monitored accumulated driving time of the plurality of fuel cell stacks depending on required power.

16. The fuel cell system control method of claim 15, further including:
determining, by the second controller, a power level of each of the fuel cell stacks, based on the required power and a number of drivable fuel cell stacks among the fuel cell stacks, and
determining, by the second controller, a number of driving fuel cell stacks, based on a value obtained by dividing the required power by power corresponding to the determined power level.

17. The fuel cell system control method of claim 15, wherein the controlling of the power of each of the fuel cell stacks by the second controller includes:
stopping, by the second controller, driving a fuel cell stack, a continuously driven time or an amount of continuously output power of which is greater than a threshold time or a threshold amount of power corresponding to the power of each of the fuel cell stack, or decreasing, by the second controller, power of the fuel cell stack.

18. The fuel cell system control method of claim 15, further including:
replacing, by the second controller, a fuel cell stack, a continuously driven time or an amount of continuously output power of which is greater than a threshold time or a threshold amount of power corresponding to the power of each of the fuel cell stack, with a fuel cell stack with a shortest accumulated driving time or a smallest amount of accumulated power among the plurality of fuel cell stacks.

19. The fuel cell system control method of claim 16, wherein the controlling of the power of each of the fuel cell stacks by the second controller includes:
determining, by the second controller, a number of representative fuel cell stacks with a smallest amount of accumulated power or a shortest accumulated driving time among the plurality of fuel cell stacks, based on the required power, the number of the driving fuel cell stacks, the power corresponding to the determined power level, and power corresponding to a power level which is one step higher than the determined power level.

20. The fuel cell system control method of claim 16, wherein the controlling of the power of each of the fuel cell stacks by the second controller includes:
determining, by the second controller, fuel cell stacks with a smallest amount of accumulated power or a shortest accumulated driving time among the plurality of fuel cell stacks as representative fuel cells; and
determining, by the second controller, power of each of remaining driven fuel cell stacks except for the representative fuel cell stacks, based on power corresponding to the determined power level; and
determining, by the second controller, power of the representative fuel cell stacks, based on a value obtained by dividing a value obtained by subtracting a sum of the power of the remaining driven fuel cell stacks except for the representative fuel cell stacks from the required power by a number of the representative fuel cell stacks.
